(19) United States
(12) Patent Application Publication
(10) Pub. No.: US 2018/0165578 A1
(43) Pub. Date: Jun. 14, 2018

(54) DEEP NEURAL NETWORK COMPRESSION APPARATUS AND METHOD

(71) Applicant: Electronics and Telecommunications Research Institute, Daejeon (KR)

(72) Inventors: Hoon CHUNG, Daejeon (KR); Jeon Gue PARK, Daejeon (KR); Sung Joo LEE, Daejeon (KR); Yun Keun LEE, Daejeon (KR)

(73) Assignee: Electronics and Telecommunications Research Institute, Daejeon (KR)

(21) Appl. No.: 15/478,342

(22) Filed: Apr. 4, 2017

(30) Foreign Application Priority Data
Dec. 8, 2016 (KR) 10-2016-0167007

(51) Int. Cl. G06N 3/08; G06F 17/16; G06N 3/04

(52) U.S. Cl. CPC G06N 3/08; G06N 3/04; G06F 17/16

(57) ABSTRACT

Provided are an apparatus and method for compressing a deep neural network (DNN). The DNN compression method includes receiving a matrix of a hidden layer or an output layer of a DNN, calculating a matrix representing a nonlinear structure of the hidden layer or the output layer, and decomposing the matrix of the hidden layer or the output layer using a constraint imposed by the matrix representing the nonlinear structure.

### CROSS-REFERENCE TO RELATED APPLICATION

This application claims priority to and the benefit of Korean Patent Application No. 10-2016-0167007, filed on Dec. 8, 2016, the disclosure of which is incorporated herein by reference in its entirety.

### BACKGROUND

### 1. Field of the Invention

The present invention relates to compression of a deep neural network (DNN), and more particularly, to an apparatus and method for compressing a DNN to efficiently calculate a DNN-based acoustic model in an embedded terminal having limited system resources.

### 2. Discussion of Related Art

Generally, a speech recognition system detects a word that results in the maximum likelihood for a feature parameter X given as Expression 1.

Word*≈argmax_{w}P(X|M)P(M|Word)P(Word) [Expression 1]

Here, the three probability models P(X|M), P(M|Word), and P(Word) respectively denote an acoustic model, a pronunciation model, and a language model.

The language model P(Word) includes probability information of word connections, and the pronunciation model P(M|Word) includes information on which phonetic symbols constitute a word. The acoustic model P(X|M) is a model of a probability that the feature vector X will be observed from phonetic symbols.

Among these three probability models, the acoustic model P(X|M) uses a DNN.

A DNN is configured with a plurality of hidden layers and a final output layer. In the DNN, calculation of W, which is a weight matrix of the hidden layers, requires the largest amount of calculation.

While general high-performance computer systems have no problem with the amount of such complex matrix calculation, the amount of calculation becomes problematic in an environment in which calculation resources are limited, such as in a smart phone.

To reduce calculation complexity of a DNN, a truncated singular value decomposition (TSVD)-based matrix decomposition is generally used in a related art.

This involves approximating W, which is an M|M hidden-layer matrix or an M|N output-layer matrix, with matrices U and V, which are M|K and K|M or M|K and K|N matrices.

W≈UV [Expression 2]

Here, Rank(UV)=K<<Rank(W).

Such a decomposition of W into UV based on TSVD finally becomes a calculation of the matrices U and V of rank K which minimize the Frobenius norm or Euclidean distance between W and UV as shown in Expression 3.

min_{U,V}∥W−UV∥² [Expression 3]

Each hidden layer of a DNN is a model of a nonlinear characteristic. However, when a value satisfying a Euclidean distance condition is calculated, a problem occurs in that such a nonlinear characteristic is changed.

Such a change in a geometric structure has influence on recognition performance of a speech recognition system, and thus it is necessary for approximation of a DNN to reflect such a nonlinear structure of a hidden layer.

### SUMMARY OF THE INVENTION

The present invention is directed to providing an apparatus and method for compressing a deep neural network (DNN) which make it possible to reduce the amount of calculation while maintaining a nonlinear structure of the DNN for speech recognition.

The present invention is not limited to the aforementioned object, and other objects not mentioned above may be clearly understood by those of ordinary skill in the art from the following descriptions.

According to an aspect of the present invention, there is provided a DNN compression method, the method including: receiving a matrix of a hidden layer or an output layer of a DNN; calculating a matrix representing a nonlinear structure of the hidden layer or the output layer; and decomposing the matrix of the hidden layer or the output layer using a constraint imposed by the matrix representing the nonlinear structure.

According to another aspect of the present invention, there is provided a DNN compression apparatus, the apparatus including: an input portion configured to receive a matrix of a hidden layer or an output layer of a DNN; a calculator configured to calculate a matrix representing a nonlinear structure of the hidden layer or the output layer; and a decomposer configured to decompose the matrix of the hidden layer or the output layer using a constraint imposed by the matrix representing the nonlinear structure.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a change in a geometric structure of a deep neural network (DNN) according to a related art;

FIG. 2 is an example diagram of a Laplacian matrix for maintaining a geometric structure of a DNN according to an exemplary embodiment of the present invention;

FIG. 3 is a flowchart of a method of compressing a DNN on the basis of a manifold constraint according to an exemplary embodiment of the present invention;

FIG. 4 is a diagram showing a structure of an apparatus for compressing a DNN on the basis of a manifold constraint according to an exemplary embodiment of the present invention; and

FIG. 5 is a diagram showing a structure of a computer system in which a method of compressing a DNN on the basis of a manifold constraint according to an exemplary embodiment of the present invention is performed.

### DETAILED DESCRIPTION OF EXEMPLARY EMBODIMENTS

Advantages and features of the present invention and a method of achieving the same should be clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Meanwhile, terminology used herein is for the purpose of describing the embodiments and is not intended to be limiting to the invention. As used in this specification, the singular form of a word includes the plural form unless clearly indicated otherwise by context. The term “comprise” and/or “comprising,” when used herein, does not preclude the presence or addition of one or more components, steps, operations, and/or elements other than the stated components, steps, operations, and/or elements.

Hereinafter, exemplary embodiments of the present invention will be described in detail with reference to the accompanying drawings.

Among probability models for speech recognition, an acoustic model P(X|M) is obtained using a deep neural network (DNN).

In general, a DNN includes hidden layers and an output layer, and the hidden layers are represented as shown in Expression 4.

z⁰=xₜ

yᵢ^{(l+1)}=Σⱼ₌₁^{N}^{^{(l)}}wᵢⱼ^{(l)}zⱼ^{(l)}+bᵢ^{(l)}

zᵢ^{(l+1)}=σ(yᵢ^{(l+1)}), [Expression 4]

y is calculated by performing an Affine transform of W and b for an input signal xₜ, and then a subsequent hidden layer z may be calculated by applying a nonlinear activation function σ to y.

Here, W and b respectively denote a weight matrix and a bias vector. Also, various functions shown in Table 1 are used as the nonlinear activation function.

TABLE 1

| Name | Function |
|---|---|
| sigmoid(y) | $\frac{1}{1 + exp ( - y )}$ |
| tanh(y) | $\frac{1 - exp ( - 2 y )}{1 + exp ( - 2 y )}$ |
| ReLU(y) | max(0, y) |
| LReLU(y) | $\{ \begin{matrix}y , & if y > 0 \\ 0.001 y , & if y ≦ 0\end{matrix}$ |
| PReLU(y) | $\{ \begin{matrix}y , & if y > 0 \\ α \cdot y , & if y ≦ 0\end{matrix}$ |
| P-sigmoid(y) | η · (1 + exp(−γy + ζ)) |

In an output layer that is the last layer of the DNN, an output value of each node is normalized into a probability value through a softmax calculation.

$$\begin{matrix}p ( s \vert {x}_{t} ) = softmax ( {x}_{t} ) \\ = \frac{exp ( {w}_{s} {y}^{L} )}{{\sum }_{n = 1}^{{N}^{( L )}} exp ( {w}_{n} {y}^{( L )} )} ,\end{matrix} \qquad [ Expression 5 ]$$

In other words, outputs exp(yᵢ^{L}) of all of N nodes of an L^{th} output layer are calculated, and then output values of the respective nodes are normalized into Σₓ^{K}exp(yₓ^{L}).

Therefore, a model parameter θ of the DNN may be defined as shown in Expression 6.

θ=[W,b,σ]. [Expression 6]

Here, since W is a weight matrix of all layers, b is a bias term, and σ is the nonlinear activation function, the calculation complexity of the DNN may be ultimately defined as the sum of amounts of calculation of W and the nonlinear function.

In terms of the amount of calculation of the DNN, the calculation complexity of the nonlinear function is lower than that of the matrix W. Therefore, an amount of calculation O(n) of the DNN is approximated into a matrix calculation of the hidden layers and the output layer as shown in Expression 7.

O(n)≈L×(M×M)+M×N [Expression 7]

Here, L is the number of hidden layers, M is the average number of hidden nodes, and N is the number of output nodes.

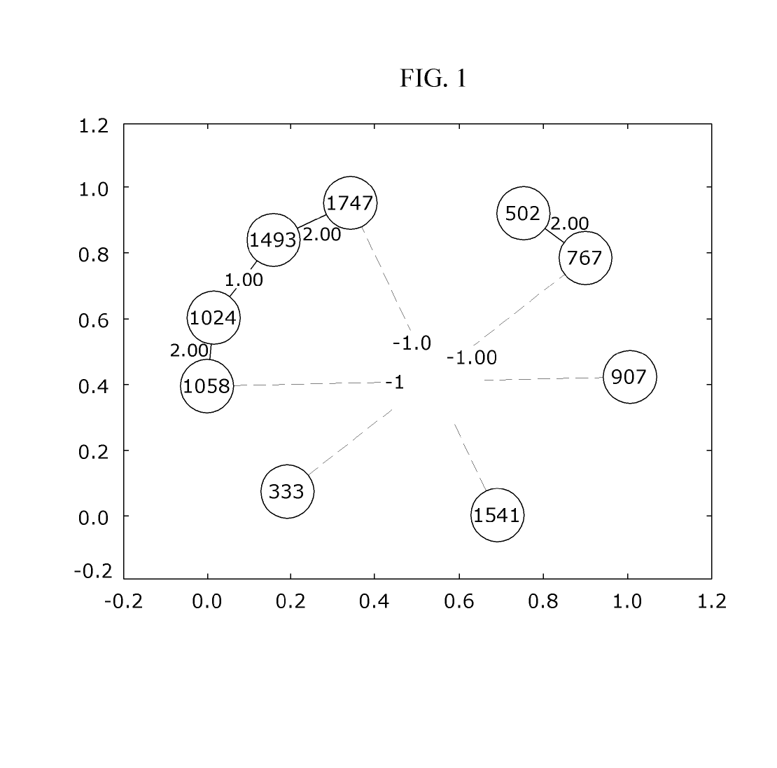

According to a related art, a distance between matrices of hidden layers in a DNN is considered as a Euclidean distance and approximated. In this case, a problem in that a manifold structure of a matrix before approximation is changed as shown in FIG. 1 occurs.

In FIG. 1, a number in each circle denotes an i^{th} column vector of a specific hidden-layer matrix W. A solid line indicates the closest column vector in W, and a dotted line indicates the closest column vector in approximated UV.

In other words, the column vector closest to a 1,747^{th} column vector before approximation is a 1,493^{rd} column vector in the matrix W, but is changed to a 1,541^{st} column vector in UV approximated using truncated singular value decomposition (TSVD). In other words, it is possible to see that a structure of the original matrix is changed by TSVD.

Therefore, to minimize a change in a manifold geometric structure occurring in this way when a DNN is compressed, it is intended that the present invention maintains a geometric structure of an original matrix even in decomposed matrices U and V by imposing a manifold structure of the original matrix as a constraint when the DNN is compressed.

A manifold structure of a DNN may be defined using a Laplacian matrix.

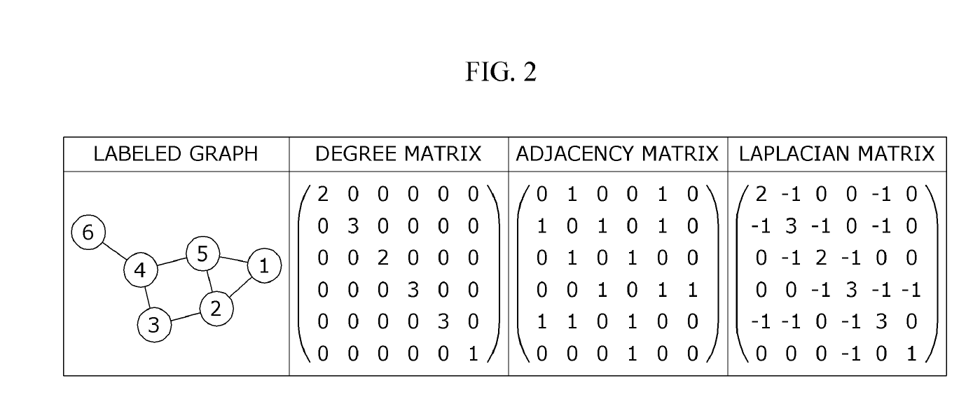

FIG. 2 is an example showing a graph having six nodes as a Laplacian matrix.

To maintain a geometric structure using a Laplacian matrix, a matrix is decomposed using an objective function shown in Expression 8.

min_{U,V}(∥W−UV∥²+αTr(VBV^{T})) [Expression 8]

It is possible to see that a constraint reflecting α is added to Expression 3, which denotes a TSVD approximation. α denotes a Lagrange multiplier.

Due to the constraint, it is possible to calculate U and V which are matrices obtained by approximating a hidden layer or an output layer while maintaining a manifold structure of a hidden-layer or output-layer matrix.

When Expression 8 is developed in a closed form, the decomposed matrices U and V may be obtained as follows.

First, C is calculated according to C=(I+αB).

The calculated C is decomposed as C=DD^{T} through a Cholesky decomposition.

W(D^{T})⁻is calculated with calculated D^{T}.

The calculated W(D^{T})⁻¹ is decomposed as W(D^{T})⁻¹≈EΣF.

U and V that are approximated as U=E, V=E^{T}WC⁻¹ are finally calculated using decomposed E.

The hidden-layer or output-layer matrix W may be simplified and expressed as the product of U and V through such operations.

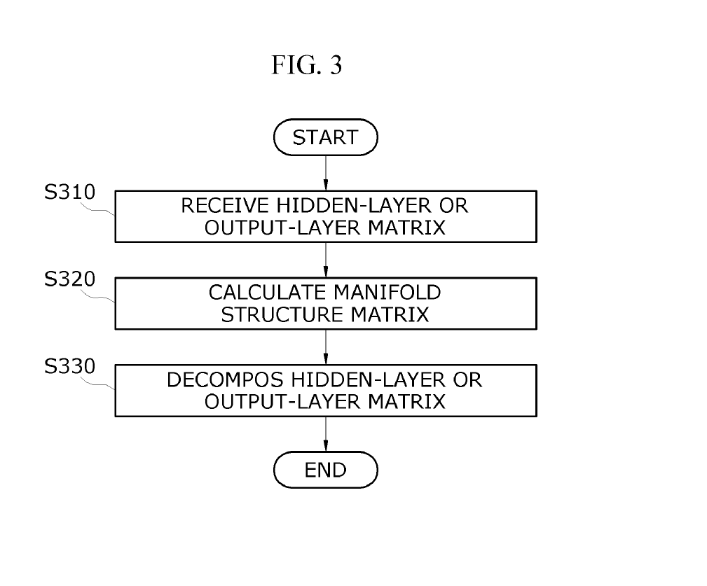

FIG. 3 is a flowchart of a method of compressing a DNN on the basis of a manifold constraint according to an exemplary embodiment of the present invention.

A DNN includes a plurality of hidden layers and an output layer. First, to compress the DNN, a hidden-layer or output-layer matrix, which is a compression target, is received (S310).

The hidden layers or the output layer of the DNN for speech recognition has a manifold structure which is a nonlinear structure. To maintain the manifold structure, a matrix representing the manifold structure is calculated (S320).

As described above, the manifold structure may be defined using a Laplacian matrix.

Finally, the hidden-layer or output-layer matrix is decomposed under a constraint of the manifold structure (S330).

To maintain a geometric structure using the Laplacian matrix, the matrix is decomposed using the aforementioned objective function of Expression 8.

When Expression 8 is developed in a closed form, decomposed matrices U and V, which satisfy Expression 8, may be obtained.

When the decomposed matrices U and V are used, it is possible to calculate the DNN with an amount of calculation far less than that of directly calculating a hidden-layer or output-layer matrix W.

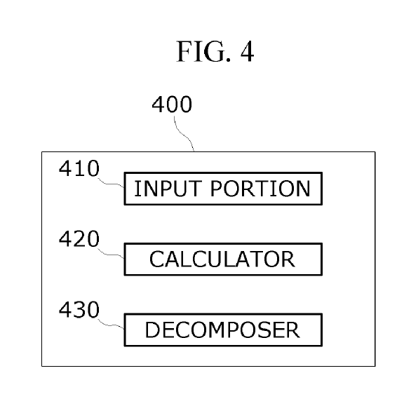

FIG. 4 is a diagram showing a structure of an apparatus 400 for compressing a DNN on the basis of a manifold constraint according to an exemplary embodiment of the present invention.

The apparatus 400 for compressing a DNN includes an input portion 410, a calculator 420, and a decomposer 430.

The input portion 410 receives a hidden-layer or output-layer matrix of a DNN which is a compression target.

The calculator 420 calculates a matrix representing a nonlinear structure of a hidden layer or an output layer of the DNN to maintain the nonlinear structure.

The nonlinear structure may be a manifold structure.

Also, a Laplacian matrix may be used to express the manifold structure.

Therefore, the calculator 420 calculates the Laplacian matrix using the matrix of the hidden layer or the output layer.

Finally, the decomposer 430 decomposes W, which is the hidden-layer or output-layer matrix, into two matrices U and V while maintaining a nonlinear structure thereof.

The decomposer 430 may use the aforementioned structure of Expression 8 to maintain the manifold structure using the Laplacian matrix.

The decomposer 430 may calculate the decomposed matrices U and V, which satisfy Expression 8, by developing Expression 8 in a closed form.

Since it is possible to maintain a manifold structure when a matrix decomposition is performed by the above-described apparatus and method for compressing a DNN, recognition performance is improved more than in a case in which a model decomposed by existing TSVD is used.

Table 2 shows effects of a matrix decomposition based on a DNN compression method according to an exemplary embodiment of the present invention.

TABLE 2

| alpha | broken nodes | RMSE | Dev | Test |
|---|---|---|---|---|
| 0.000 | 511 | 0.033759 | 21.1 | 22.3 |
| 0.001 | 495 | 0.033759 | 21.2 | 22.2 |
| 0.005 | 434 | 0.033763 | 21.1 | 22.2 |
| 0.01 | 369 | 0.033776 | 21.3 | 21.9 |
| 0.02 | 279 | 0.033822 | 21.9 | 22.1 |

Since Test denotes an error rate, a lower value of Test denotes a better result.

These effects are results obtained by decomposing a 1,024×1,943 output layer of a DNN into a 1,024×64 layer and a 64×1,943 layer and evaluating the decomposed layers based on Texas Instruments and Massachusetts Institute of Technology (TIMIT), which is a standard evaluation environment relating to speech recognition performance. TIMIT is a corpus of phonemically and lexically transcribed speech of American English speakers of different sexes and dialects.

When alpha (α) is 0, the aforementioned method is identical to TSVD which is the related art, and when alpha is not 0, the aforementioned method is a decomposition method for maintaining a manifold structure according to the present invention.

When alpha is 0, that is, when a Euclidean distance is used, there are 511 broken nodes, that is, nodes whose geometric structures are changed, and an error rate is 22.3%.

On the other hand, when alpha is not 0, it is possible to see that the number of broken nodes is reduced to be smaller than 511 and the error rate is also reduced. When alpha is 0.01, the error rate is 21.9%, which is the lowest value, and the number of broken nodes is remarkably reduced to 369.

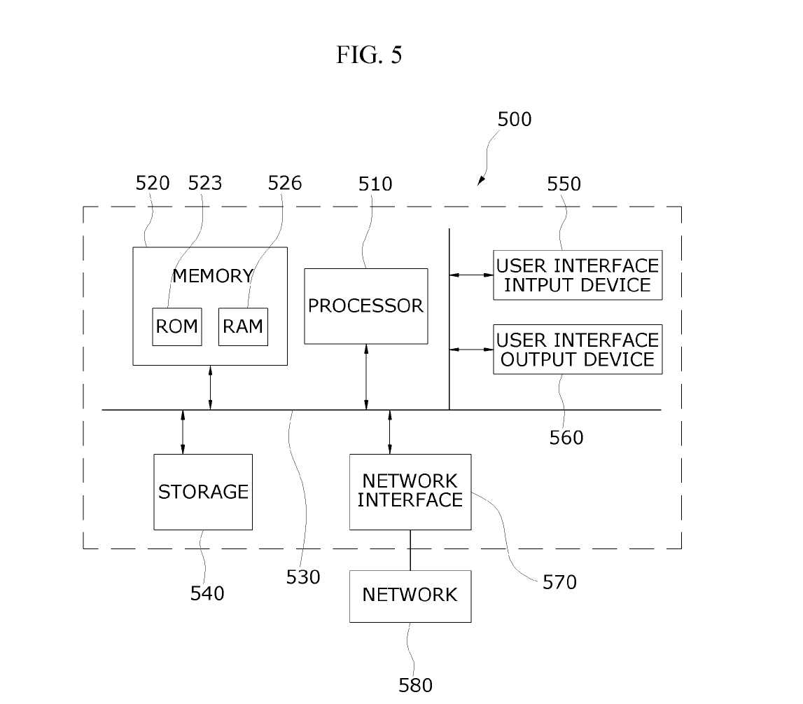

Meanwhile, a method of compressing a DNN on the basis of a manifold constraint according to an exemplary embodiment of the present invention may be implemented by a computer system or may be recorded on a recording medium. As shown in FIG. 5, the computer system may include at least one processor 510, a memory 523, a user input device 550, a data communication bus 530, a user output device 560, and a storage 540. Each of the aforementioned components performs data communication through a data communication bus 530.

The computer system may further include a network interface 570 coupled to a network 580. The processor 510 may be a central processing unit (CPU) or a semiconductor device which processes instructions stored in the memory 520 and/or the storage 540.

The memory 520 and the storage 540 may include various forms of volatile or non-volatile storage media. For example, the memory 520 may include a read-only memory (ROM) 523 and a random access memory (RAM) 526.

Therefore, a method of compressing a DNN on the basis of a manifold constraint according to an exemplary embodiment of the present invention may be implemented as a method executable by a computer. When the method of compressing a DNN on the basis of a manifold constraint according to an exemplary embodiment of the present invention is performed by a computing device, a recognition method according to the present invention may be performed through computer-readable instructions.

Meanwhile, the above-described method of compressing a DNN on the basis of a manifold constraint according to an exemplary embodiment of the present invention may be implemented as a computer-readable code in a computer-readable recording medium. The computer-readable recording medium includes any type of recording medium in which data readable by a computer system is stored. Examples of the computer-readable recording medium may be a ROM, a RAM, a magnetic tape, a magnetic disk, a flash memory, an optical data storage device, and the like. Also, the computer-readable recording medium may be distributed in computer systems that are connected via a computer communication network so that the computer-readable recording medium may be stored and executed as codes readable in a distributed manner.

According to exemplary embodiments of the present invention, a DNN is compressed while a nonlinear characteristic of the DNN is maintained, so that complexity of calculation is reduced. Therefore, it is possible to reduce the probability of an error while reducing the amount of calculation.

The above description of the present invention is exemplary, and those of ordinary skill in the art should appreciate that the present invention can be easily carried out in other detailed forms without changing the technical spirit or essential characteristics of the present invention. Therefore, it should also be noted that the scope of the present invention is defined by the claims rather than the description of the present invention, and the meanings and ranges of the claims and all modifications derived from the concept of equivalents thereof fall within the scope of the present invention.

What is claimed is:

1. A deep neural network (DNN) compression method performed by at least one processor, the method comprising:
receiving a matrix of a hidden layer or an output layer of a DNN;
calculating a matrix representing a nonlinear structure of the hidden layer or the output layer; and
decomposing the matrix of the hidden layer or the output layer using a constraint imposed by the matrix representing the nonlinear structure.

2. The DNN compression method of claim 1, wherein the calculating of the matrix includes expressing the nonlinear structure as a manifold structure and calculating the matrix.

3. The DNN compression method of claim 2, wherein the calculating of the matrix includes calculating the matrix representing the manifold structure using a Laplacian matrix.

4. The DNN compression method of claim 1, wherein the decomposing of the matrix includes decomposing the hidden layer or the output layer into matrices satisfying an expression below:
min_{U,V}(∥W−UV∥²+αTr(VBV^{T})) [Expression]
(W: the hidden-layer or output-layer matrix, U and V: the matrices obtained by decomposing the hidden-layer or output-layer matrix, α: a Lagrange multiplier, and B: a Laplacian matrix representing a nonlinear structure of the DNN).

5. The DNN compression method of claim 4, wherein the decomposing of the hidden layer or the output layer into the matrices satisfying the above expression includes:
calculating C according to C=(I+αB);
decomposing C as C=DD^{T} through a Cholesky decomposition;
calculating W(D^{T})⁻¹ with D^{T};
decomposing WD^{T-1} as W(D^{T})⁻¹≈EΣF; and
calculating U=E, V=E^{T}WC⁻¹ using E.

6. A deep neural network (DNN) compression apparatus including at least one processor, wherein the processor comprises:
an input portion configured to receive a matrix of a hidden layer or an output layer of a DNN;
a calculator configured to calculate a matrix representing a nonlinear structure of the hidden layer or the output layer; and
a decomposer configured to decompose the matrix of the hidden layer or the output layer using a constraint imposed by the matrix representing the nonlinear structure.

7. The DNN compression apparatus of claim 6, wherein the calculator expresses the nonlinear structure as a manifold structure and calculates the matrix.

8. The DNN compression apparatus of claim 7, wherein the calculator calculates the matrix representing the manifold structure using a Laplacian matrix.

9. The DNN compression apparatus of claim 6, wherein the decomposer decomposes the hidden layer or the output layer into matrices satisfying an expression below:
min_{U,V}(∥W−UV∥²+αTr(VBV^{T})) [Expression]
(W: the hidden-layer or output-layer matrix, U and V: the matrices obtained by decomposing the hidden-layer or output-layer matrix, α: a Lagrange multiplier, and B: a Laplacian matrix representing a nonlinear structure of the DNN).

10. The DNN compression apparatus of claim 9, wherein the decomposer calculates the matrices U and V satisfying the above expression by calculating C according to C=(I+αB), decomposing C as C=DD^{T} through a Cholesky decomposition, calculating W(D^{T})⁻¹ with D^{T}, decomposing WD^{T-1} as W(D^{T})⁻¹≈EΣF, and calculating U=E, V=E^{T}WC⁻¹ using E.
